(19) United States
(12) Patent Application Publication
(10) Pub. No.: US 2026/0092140 A1
(43) Pub. Date: Apr. 2, 2026

(54) BRANCHED WHOLLY AROMATIC POLYESTERS

(71) Applicant: EDISON MATERIALS CO., LTD., Toufen City (TW)

(72) Inventors: Hung-Yi Hsu, Zhubei City (TW); Hung-Hsiang Lu, Zhubei City (TW); Chain-Shu Hsu, Zhubei City (TW)

(21) Appl. No.: 18/903,159

(22) Filed: Oct. 1, 2024

(51) Int. Cl. C08G 63/183; C08G 63/127; C08G 63/133; C08G 63/78

(52) U.S. Cl. CPC C08G 63/183; C08G 63/127; C08G 63/133; C08G 63/785

(57) ABSTRACT

Unlike traditional thermotropic liquid crystal polymers (TLCPs), which exhibit anisotropy (or directionality), the disclosed branched wholly aromatic polyesters (bPs) exhibit greater isotropy and, consequently, reduce (or even eliminate) direction-dependent performance characteristics. By making the polymers more isotropic, the bPs are more suitable for 5G (and similar) applications than conventional TLCPs.

### BACKGROUND

### Field of the Disclosure

The present disclosure relates generally to polymers and, more particularly, to branched wholly aromatic polyesters.

### Description of Related Art

5G (which, in telecommunications, stands for fifth-generation technology standard for cellular networks) is capable of delivering peak data rates of up to twenty gigabits per second (20 Gbps). Achieving these high data rates often requires printed circuit boards (PCBs) that are capable of high-frequency applications. Consequently, there are ongoing efforts to develop PCB materials that are suitable for 5G applications.

### SUMMARY

The present disclosure teaches branched wholly aromatic polyesters (bP) that are suitable for 5G applications, along with processes for manufacturing such bPs.

Briefly described, unlike traditional thermotropic liquid crystal polymers (TLCPs), which exhibit anisotropy (or directionality), the disclosed bPs exhibit greater isotropy and, consequently, reduce (or even eliminate) direction-dependent performance characteristics. By making the polymers more isotropic, the bPs are more suitable for 5G (and similar) applications than conventional TLCPs.

Some embodiments of the bPs include a bP in which aromatic compounds with at least three (3) functional groups provide branching locations between chains of aromatic compounds with two (2) functional groups. These branching locations produce trifunctional moieties or tetrafunctional moieties (or even higher-functional moieties, depending on the number of functional groups on the aromatic compounds), thereby producing bPs with isotropic performance characteristics.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a flowchart showing initial steps in one embodiment of a process for manufacturing branched wholly aromatic polyesters (bPs).

FIG. 1B is a flowchart showing additional steps of the embodiment of the process shown in FIG. 1A.

FIG. 1C is a flowchart showing additional steps of the embodiment of the process shown in FIGS. 1A and 1B. Collectively, FIGS. 1A, 1B, and 1C are designated herein as FIG. 1.

FIG. 2A is a flowchart showing one embodiment of process steps in which specific starting materials are added as part of the manufacturing process of FIG. 1.

FIG. 2B is a flowchart showing one embodiment of a first heating step of FIG. 1.

FIG. 2C is a flowchart showing one embodiment of a second heating step of FIG. 1.

FIG. 2D is a flowchart showing one embodiment of a third heating step of FIG. 1. Collectively, FIGS. 2A, 2B, 2C, and 2D are designated herein as FIG. 2.

FIG. 3 is a flowchart showing one embodiment of process steps in which specific amounts of starting materials are shown as part of the manufacturing process of FIG. 2A.

FIG. 4 is a flowchart showing another embodiment of process steps in which specific starting materials are added as part of the manufacturing process of FIG. 1.

FIG. 5 is a flowchart showing one embodiment of process steps in which specific amounts of starting materials are shown as part of the manufacturing process of FIG. 4

FIG. 6A is a diagram showing one embodiment of a chemical reaction with the starting materials of FIG. 2A, also showing intermediate products (sometimes designated simply as intermediates) and end products (sometimes designated simply as products).

FIG. 6B is a diagram showing one embodiment of a bP with trifunctional moieties.

FIG. 6C is a diagram showing one embodiment of a bP with tetrafunctional moieties.

FIG. 7 is a diagram showing one embodiment of suitable starting materials for the processes of FIGS. 1 through 5, showing representative aromatic compounds with at least three (3) functional groups.

FIG. 8 is a diagram showing another embodiment of suitable starting materials for the processes of FIGS. 1 through 5, showing other representative aromatic compounds with at least three (3) functional groups.

FIG. 9 is a diagram showing one embodiment of suitable starting materials for the processes of FIGS. 1 through 5, showing representative aromatic compounds with two (2) functional groups.

FIG. 10 is a diagram showing another embodiment of suitable starting materials for the processes of FIGS. 1 through 5, showing other representative aromatic compounds with two (2) functional groups.

FIG. 11 is a diagram showing yet another embodiment of suitable starting materials for the processes of FIGS. 1 through 5, showing yet other representative aromatic compounds with two (2) functional groups.

### DETAILED DESCRIPTION OF THE EMBODIMENTS

5G (short for fifth generation) networks are capable of delivering peak data rates of up to twenty gigabits per second (20 Gbps). Achieving these high data rates often requires printed circuit boards (PCBs) that are capable of high-frequency applications.

Thermotropic liquid crystal polymers (TLCPs), which are known in the art, have been proposed as suitable materials for use in flexible printed circuit boards (FPCBs). For use in FPCBs, TLCPs are typically extruded from a machine in one direction (designated herein as a “machine direction” or MD, with a direction that is normal to the MD being designated a “transverse direction” or TD). However, because TLCPs are subsets of liquid crystal polymers (which have a directionality), TLCPs correspondingly exhibit directionality when extruded to form films; in other words, TLCPs exhibit an anisotropy due to the directionality of their component structures. Consequently, performance characteristics in the MD are oftentimes remarkably different from performance characteristics in the TD, which becomes problematic for high-frequency applications, such as 5G applications.

This disclosure seeks to ameliorate issues that arise from the anisotropy in TLCPs by introducing branch points to create a branched wholly aromatic polyester (bP). Unlike traditional TLCPs, the bP exhibits greater isotropy and, consequently, reduces (or even eliminates) direction-dependent performance characteristics. By making the polymer more isotropic, the bP is more suitable for 5G (and similar) applications than conventional TLCPs.

Some embodiments of the bPs include a bP in which aromatic compounds with at least three (3) functional groups provide branching locations between chains of aromatic compounds with two (2) functional groups. These branching locations produce trifunctional moieties or tetrafunctional moieties (or even higher-functional moieties, depending on the number of functional groups on the aromatic compounds), thereby producing bPs with isotropic performance characteristics.

Having provided a broad technical solution to a technical problem, reference is now made in detail to the description of the embodiments as illustrated in the drawings. For some embodiments, as described in greater detail below, chemical reactions that form the bPs take place in a conventional temperature-controllable reactor that is equipped with a mechanical stirrer, nitrogen inlet tube, and a distillation head that is connected to a condenser. Insofar as these types of conventional reactors are well known to those having ordinary skill in the art, only a truncated discussion of such conventional reactors is provided herein, with emphasis being placed on the materials and conditions that are relevant to forming the bPs. Although several embodiments are described in connection with these drawings, there is no intent to limit the disclosure to the embodiment or embodiments disclosed herein. On the contrary, the intent is to cover all alternatives, modifications, and equivalents.

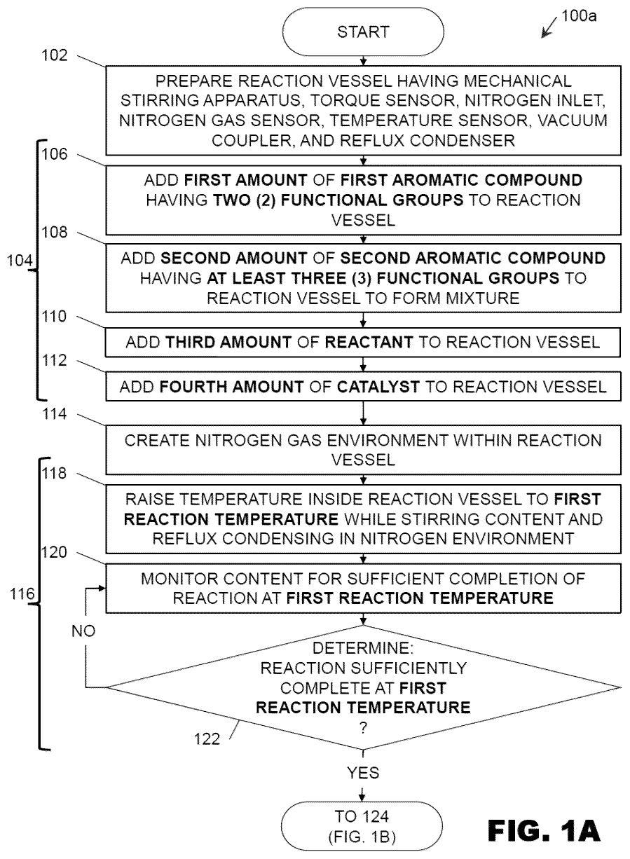

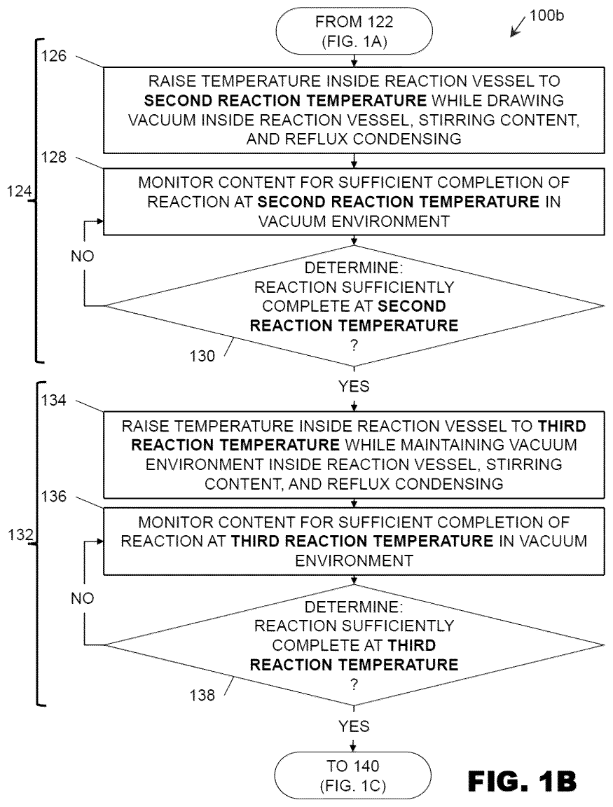

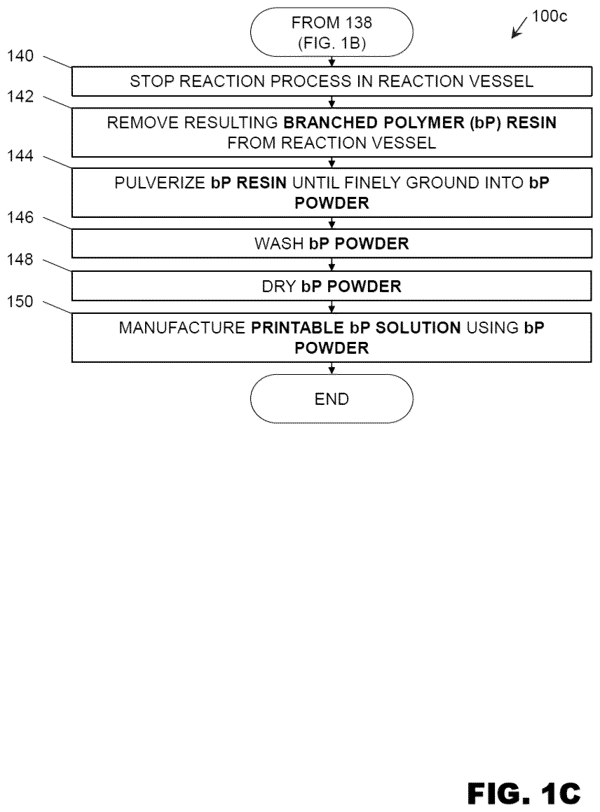

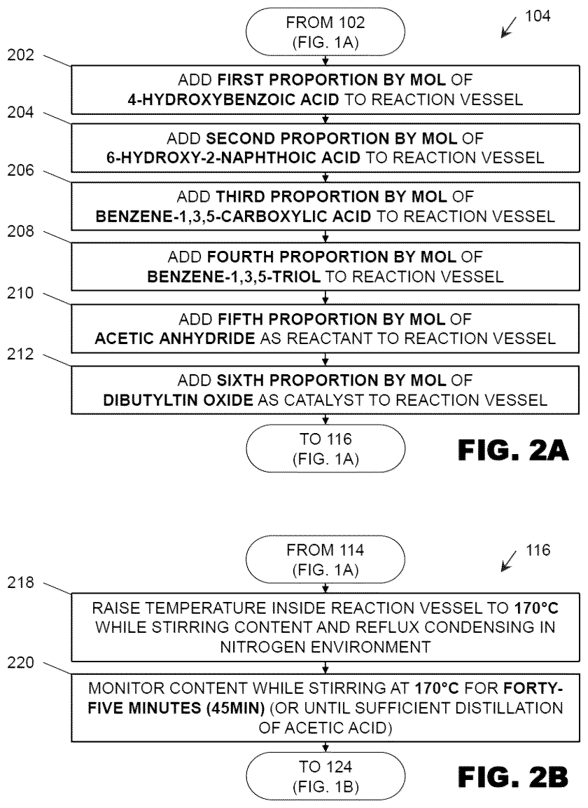

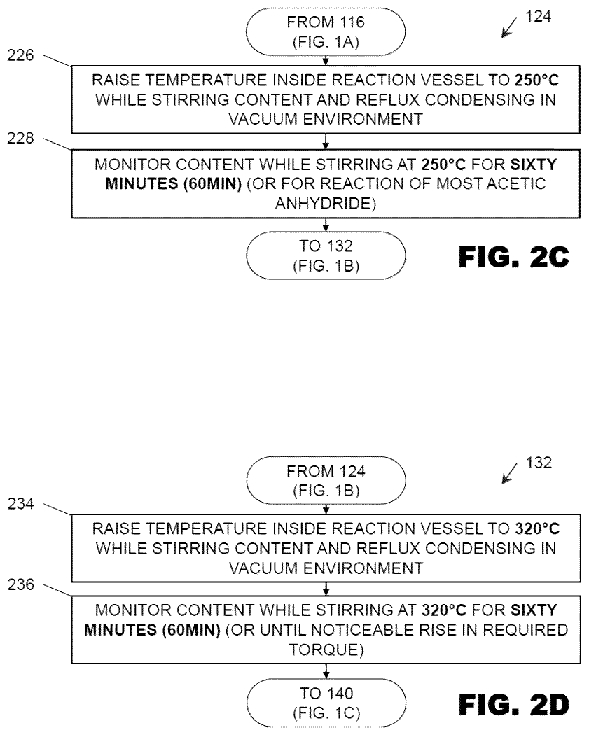

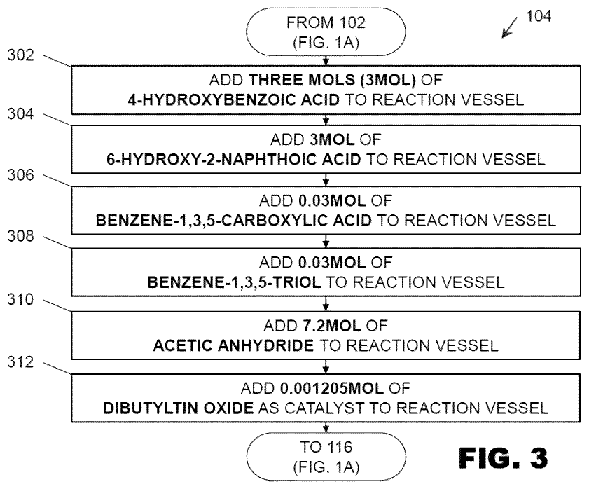

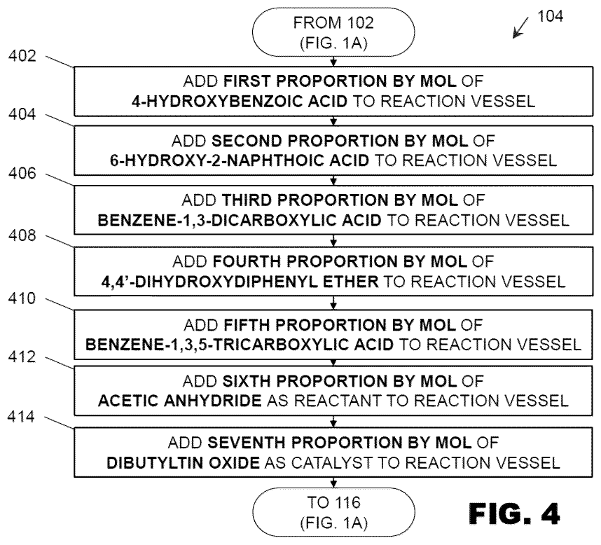

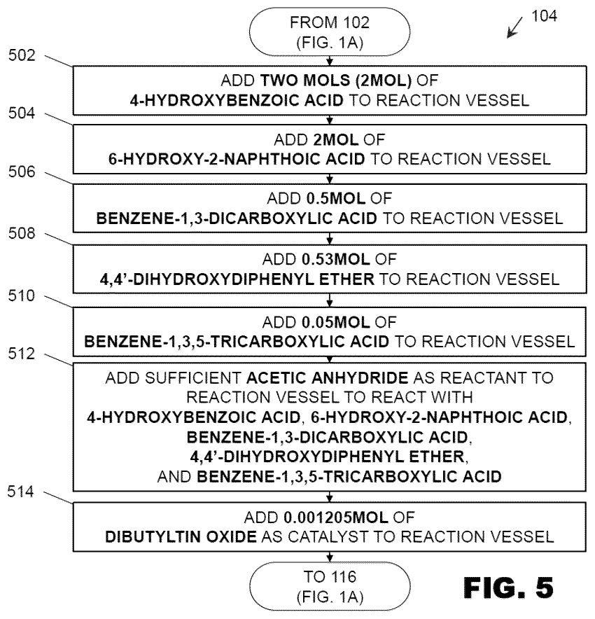

With this in mind, attention is turned to FIGS. 1A, 1B, and 1C (collectively designated herein as FIG. 1), which are flowcharts showing one embodiment of a process 100a, 100b, 100c (collectively designated herein as 100) for manufacturing a bP. As shown in FIG. 1A, the process 100a begins by preparing 102 a reaction vessel. For some embodiments, the reaction vessel comprises a mechanical stirring apparatus, a torque sensor (that measures how much torque is applied by the stirring apparatus), a nitrogen inlet (for introducing nitrogen gas to the reaction vessel), a nitrogen sensor (for measuring nitrogen content within the reaction vessel), a temperature sensor (such as a thermometer or a thermocouple), a vacuum coupler (for drawing a vacuum to create a vacuum environment within the reaction vessel), and a reflux condenser. As one having ordinary skill in the art will appreciate, these components of the reaction vessel are conventional components that are well known in the art. Consequently, only a truncated discussion of these conventional components and their respective functions is provided herein and only as necessary to further explain various aspects of the disclosed embodiments.

The step of preparing 102 the reaction vessel includes cleaning the vessel and other conventional steps for preparing 102 such a reaction vessel. Insofar as those conventional steps are known to those having ordinary skill in the art, only a truncated discussion of the preparation step 102 is provided herein.

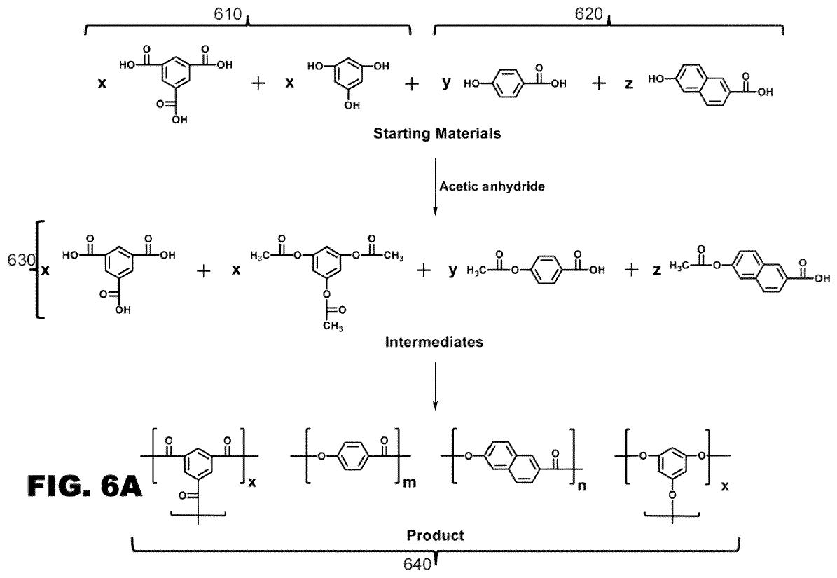

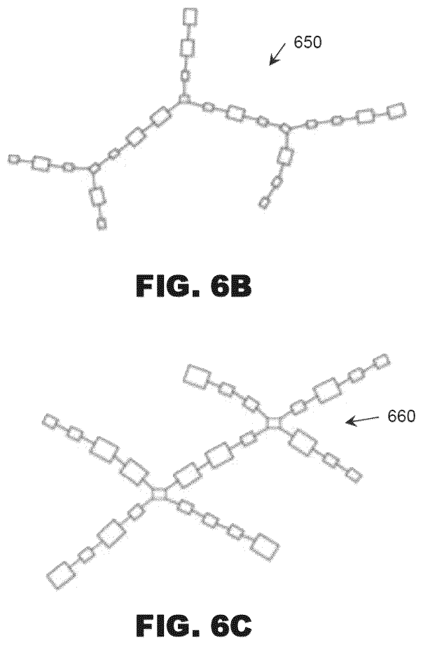

Once the vessel has been prepared 102, the process 100a adds 104 starting materials to the reaction vessel. By way of example, for one of the starting materials in the embodiment of FIG. 1A, the process adds 106 an amount (for clarity, designated as a first amount) of one or more first aromatic compounds to the reaction vessel. Each of the first aromatic compounds has two (2) functional groups. By way of example, non-limiting embodiments of the first aromatic compounds include 3-hydrobenzoic acid, 4-hydrobenzoic acid, 6-hydroxy-2-naphthoic acid, phthalic acid, benzene-1,3-dicarboxylic acid, terephthalic acid, 4,4′-oxydibenzoic acid, pyrocatechol, resorcinol, 4,4′-dihydroxydiphenyl ether, 4,4′-(propane-2,2-diyl)diphenol, or any combination of thereof. For clarity, chemical structures for example first aromatic compounds are shown in FIGS. 6A, 9, 10, and 11.

In addition to adding 106 one or more of the first aromatic compound, the process 100a also adds 108 (as starting material) an amount (for clarity, designated as a second amount) of one or more second aromatic compounds to the reaction vessel. The combination of the one or more first aromatic compounds and the one or more second aromatic compounds produces a mixture that eventually forms the structural building blocks for a branched wholly aromatic polyester (bP) that is suitable for 5G applications. Each of the second aromatic compounds has at least three (3) functional groups. By way of example, non-limiting embodiments of the second aromatic compounds include benzene-1,3,5-triol, benzene-1,2,4-triol, benzene-1,2,3-triol, benzene-1,2,4,5-tetrol, benzene-1,3,5-tricarboxylic acid, benzene-1,2,4-tricarboxylic acid, benzene-1,2,3-tricarboxylic acid, benzene-1,3,4,5-tetracaboxylic acid, 4,4′-oxydiphthalic acid, and 4,4′-oxybis(benzene-1,2-diol), or any combination thereof. For clarity, chemical structures for example second aromatic compounds are shown in FIGS. 6A, 7, and 8.

Eventually, the one or more first aromatic compounds form repeating units (which are linear because there are only two functional groups in the first aromatic compounds), while the one or more second aromatic compounds form branching locations (because of the three or more functional groups in the second aromatic compounds). For convenience and consistency within this disclosure, the combination of the first aromatic compound (linear) and the second aromatic compound (branching) is denoted herein as a starting mixture or, simply, the mixture. Insofar as fewer branching locations are needed as compared to repeating (linear) units, the first amount contributes to approximately ninety percent (˜90%) to ˜99% of the mixture, while the second amount contributes to ˜1% to ˜10% of the mixture.

Continuing with FIG. 1A, in addition to adding 106, 108 these aromatic compounds, the process 100a adds 110 an amount (for clarity, designated as a third amount) of reactant to the reaction vessel. For the aromatic compounds recited above, a suitable reactant is acetic anhydride. The third amount is an amount that is sufficient to react with all of the first and second aromatic compounds that have been added 106, 108 to the reaction vessel. Insofar as those having ordinary skill in the art can readily calculate the amount of acetic anhydride that is necessary to completely react with known quantities of the first and second aromatic compounds, the precise steps of calculating that third amount are not recited herein.

As a last part of adding 104 the starting materials, the process 100a adds 112 an amount (for clarity, designated as fourth amount) of a catalyst to the reaction vessel. For the aromatic compounds and the acetic anhydride recited above, a suitable catalyst is dibutyltin oxide. Because only a small amount of catalyst is needed, this fourth amount is usually less than approximately 0.01 mols (˜0.01 mol) of dibutyltin oxide. Depending on the precise proportion by mol of the aromatic compounds and the acetic anhydride, the amount of dibutyltin oxide can be as low as ˜0.001205 mol. For simplicity, the combination of the mixture, the reactant, and the catalyst is designated herein as a starting content or, simply, content.

After all of the content has been added 104 to the reaction vessel, the process 100a creates 114 a nitrogen gas environment within the reaction vessel. As is known in the art, the nitrogen gas environment can be created 114 by introducing nitrogen gas into the reaction vessel through, for example, the nitrogen inlet, thereby displacing the gases within the reaction vessel with nitrogen. Because there are well-known processes for creating 114 a nitrogen gas environment, only a truncated discussion of this nitrogen-gas-creating step 114 is discussed herein.

Once the contents are in the nitrogen gas environment within the reaction vessel, the process 100a proceeds to a first heating step 116. For the embodiment of FIG. 1A, the first heating step 116 begins by raising 118 an inside temperature of the reaction vessel to a first reaction temperature. For one embodiment, the first reaction temperature is approximately one-hundred and seventy degrees Celsius (˜170 °C.). The temperature is raised 118 while the content is stirred (for example, using the stirring apparatus). Because of the raised 118 temperature, there is a possibility that vapors form during the stirring. To recapture those vapors, the stirring is done in conjunction with reflux condensing or reflux condensation (using, for example, the reflux condenser).

The process 100a monitors 120 the content to determine 122 (preferably in near-real-time) whether or not a reaction at the first heating stage (or a reaction at the first reaction temperature) has been completed. For some embodiments, the completion of the first heating stage 116 is determined 122 by passage of time, such as, for example, a stirring time of approximately forty-five minutes (˜45 min) at ˜170 °C. For other embodiments, the completion of the first heating stage 116 is determined 122 by whether or not there has been a sufficient distillation of acetic acid from the reaction. Of course, as those having skill in the art will appreciate, the sufficiency of distillation can be measured by setting a threshold amount of production of any intermediate compound. For the example compounds recited above that react with acetic anhydride, a measure of an amount of acetic acid can serve as an indicator of whether or not the reaction is sufficiently completed. Of course, those having ordinary skill in the art will appreciate the different conventional approaches to monitoring 120 and determining 122 the progress of a chemical reaction in a reaction vessel. Therefore, only this truncated discussion of the monitoring 120 and determining 122 steps is provided herein.

If the process 100a determines 122 that the reaction is not sufficiently complete (using conventional means), then the process 100a continues to monitor 120 the contents (or the reaction within the reaction vessel). If, however, the process 100a determines 122 that the reaction is sufficiently complete (e.g., enough stirring time has elapsed or enough intermediate byproducts have been detected), then the process 100a of FIG. 1A continues to FIG. 1B to a second heating stage 124.

As shown in FIG. 1B, the process 100b (in response to the first heating stage 116 being sufficiently complete) raises 126 the inside temperature of the reaction vessel to a second reaction temperature. For one embodiment, the second reaction temperature is ˜250°C. The temperature is raised 126 while concurrently stirring the content, drawing a vacuum inside the reaction vessel (or evacuating the reaction vessel), and reflux condensing. The vacuum draws out unwanted gaseous byproducts from the reaction at this raised 126 second reaction temperature.

As with the first heating stage 116, the process 100b in the second heating stage 124 continues to monitor 128 the content to determine 130 (preferably in near-real-time) whether or not the reaction at the second heating stage (at the second reaction temperature) has been completed. For some embodiments, the completion of the second heating stage 124 is determined 130 by the passage of time, such as, for example, a stirring time of ˜60 min at ˜250° C. in an evacuated (or vacuum) environment. For other embodiments, the completion of the second heating stage 124 is determined 130 by whether or not there enough of the acetic anhydride (reactant) has reacted with the aromatic mixture (first and second aromatic compounds). Again, insofar as measuring whether or not the reaction is sufficiently completed is within the knowledge of one having ordinary skill in the art, the monitoring 128 and determining 130 steps for the second heating stage 124 are not described in greater detail.

If the process 100b determines 130 that the reaction is not sufficiently complete (using conventional means known to those having ordinary skill in the art), then the process 100b continues monitoring 128 the contents (or the reaction within the reaction vessel). If, however, the process 100b determines 130 that the reaction is sufficiently complete (e.g., enough stirring time has elapsed or that there are no more reactants remaining to continue the reaction), then the process 100b continues to a third heating stage 132.

In the third heating stage 132, the inside temperature of the reaction vessel is raised 134 again to a third reaction temperature. For some embodiments, the third reaction temperature is ˜320°C. The inside temperature is raised 134 while stirring the contents and reflux condensing in an evacuated environment, similar to the second heating stage 124. At this juncture of the process 100b, much of the reactants have been used for the reaction, thereby producing what would be a near-final form of the branched wholly aromatic polyester (bP). Consequently, the main purpose of this third heating stage 132 is to convert the final chemical form of the bP into a resin form for later processing. Consequently, the process 100b continues to monitor 136 the content to determine 138 whether or not the reaction at the third heating stage (at the third reaction temperature) has been completed.

For some embodiments, the completion of the third heating stage 132 is determined 138 by the passage of time, such as, for example, a stirring time of ˜60 min at ˜320° C. in an evacuated (or vacuum) environment. For other embodiments, the completion of the third heating stage 132 is determined 138 by a measurable increase in torque that is required to continue stirring the content. By way of example, the increase in torque can be measured with a torque meter or other known or conventional means. Again, insofar as measuring whether or not the reaction is sufficiently completed (e.g., torque measurements) is within the knowledge of one having ordinary skill in the art, the monitoring 136 and determining 138 steps for the third heating stage 132 are not described in greater detail.

If the process 100b determines 138 that the reaction is not sufficiently complete, then the monitoring 128 continues. If, however, the process 100b determines 138 that the reaction is sufficiently complete (e.g., measurable increase in torque), then the process 100b of FIG. 1B continues to FIG. 1C, where the reaction process 100c inside of the reaction vessel is stopped 140. Thereafter, the resulting bP resin is removed 142 from the reaction vessel, pulverized 144 until finely ground into bP powder, the bP powder is washed 146 with distilled water (or other suitable washing solution), and then dried 148. For some embodiments, a drying time of ˜1 hr at a temperature of ˜150° C. is sufficient to completely dry 148 the bP powder, which can later be manufactured 150 into a printable solution for flexible printed circuit boards (FPCBs). Insofar as the removing 142, pulverizing 144, washing 146, drying 148, and manufacturing 150 into printable solutions are conventional steps that are familiar to those having ordinary skill in the art, only a truncated discussion of the process 100c of FIG. 1C is provided herein.

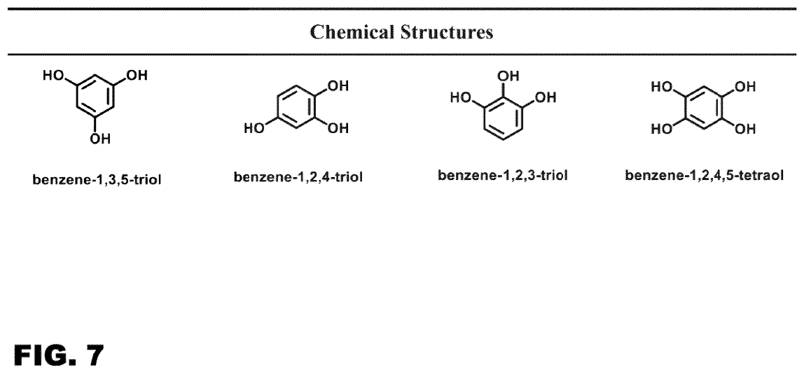

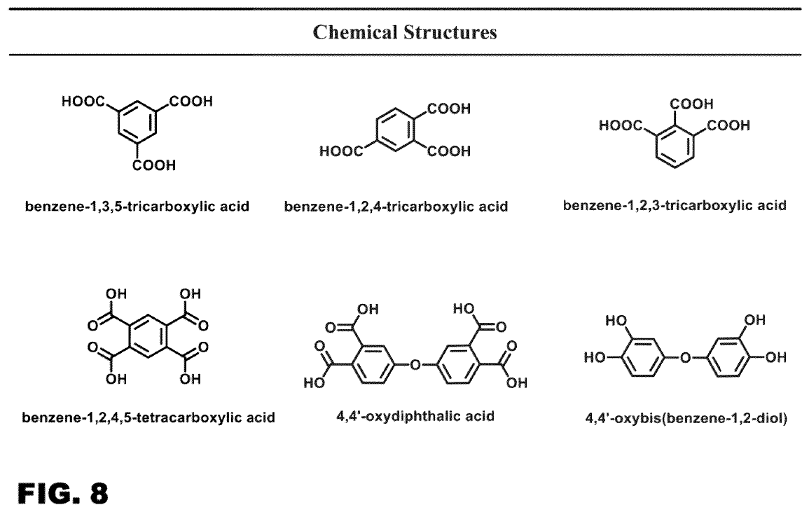

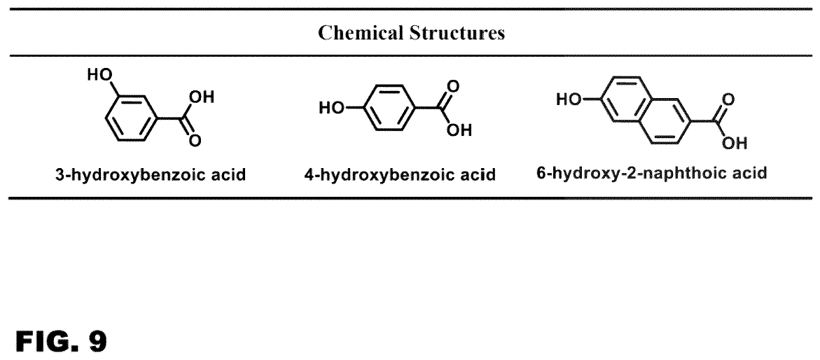

Ultimately, the end product of the process of FIG. 1 is a powder with bPs that have trifunctional moieties 650 (such as those shown in FIG. 6B), bPs having tetrafunctional moieties 660 (such as those shown in FIG. 6C), or a combination of both trifunctional 650 and tetrafunctional 660 moieties. In other words, the end product is a bP comprising both a first amount of one or more first aromatic compounds, wherein each of the one or more first aromatic compounds consists of two (2) functional groups, and a second amount of one or more second aromatic compounds, wherein each of the one or more second aromatic compounds comprise at least three (3) functional groups. Examples of the first aromatic compounds are shown in FIGS. 9, 10, and 11. Those first aromatic compounds forms one or more repeating units, wherein each of the one or more repeating units is formed at each of the two functional groups. Examples of the second aromatic compounds are shown in FIGS. 7 and 8. Those second aromatic compounds form one or more branching locations in the bP.

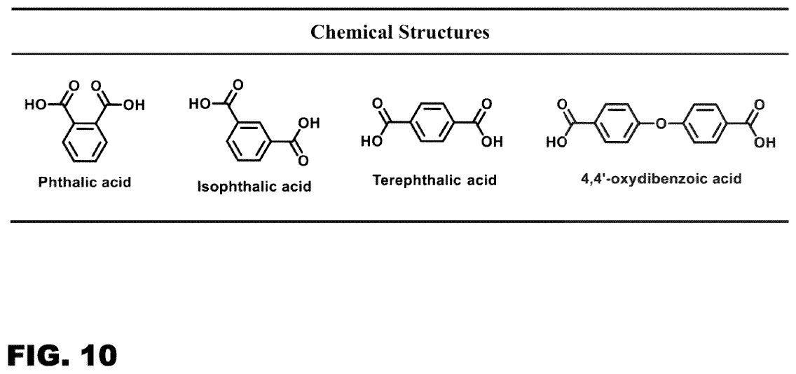

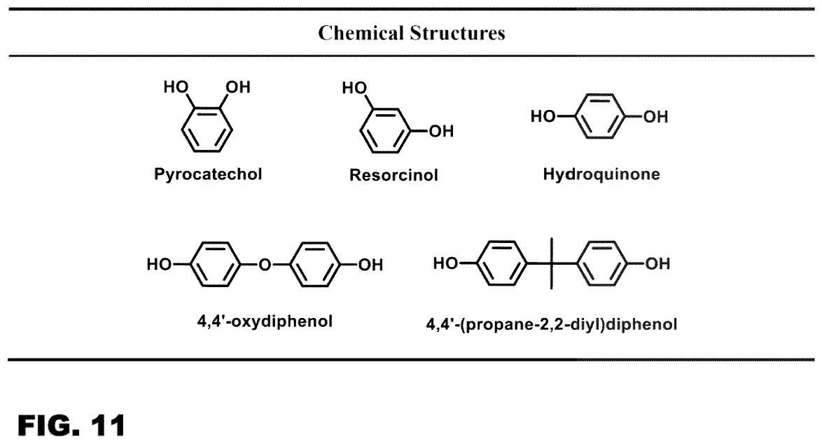

For embodiments in which the second aromatic compound is selected from one or more of the aromatic compounds in FIG. 7, a preferred mol fraction for those second aromatic compounds in the bP is between approximately one percent (˜1%) and ˜10%. For embodiments in which the second aromatic compound is selected from one or more of the aromatic compounds in FIG. 8, a preferred mol fraction for those second aromatic compounds in the bP is between ˜1% and ˜10%. For embodiments in which the first functional group is selected from one or more of the aromatic compounds in FIG. 9, a preferred mol fraction of those first compounds in the bP is between ˜20% and ˜78%. For embodiments in which the first functional group is selected from one or more of the aromatic compounds in FIG. 10, a preferred mol fraction of those compounds in the bP is between ˜10% and ˜30%. For embodiments in which the first functional group is selected from one or more of the aromatic compounds in FIG. 11, a preferred mol fraction of those compounds in the bP is between ˜10 and ˜30%.

Ultimately, in contrast to conventional TLCPs (which exhibit anisotropy and, thus, directional performance characteristics), the bPs disclosed herein generally exhibit isotropic performance characteristics in all directions, thereby making the disclosed bPs more suitable for 5G applications (and similar high-frequency applications). Specifically, the bPs produced by the process of FIG. 1 provide excellent electrical characteristics, including low dielectric constants (dk), low dissipation factors (df), low moisture absorbability, and isotropic (or uniform) behavior in both MD and TD.

With the advantages of FIG. 1 in mind, attention is turned to FIG. 2A, which shows a flowchart for one embodiment of process steps in which specific starting materials are added 104 as part of the manufacturing process 100 of FIG. 1. In other words, FIG. 2A describes with greater specificity the mixture and the content within the reaction vessel from the process 100 of FIG. 1.

As shown in FIG. 2A, the process adds 202 a first proportion (by mol) of 4-hydrobenzoic acid and also adds 204 a second proportion (by mol) of 6-hydroxy-2-naphthoic acid to the reaction vessel. The 4-hydroxybenzoic acid and the 6-hydroxy-2-naphthoic acid in FIG. 2A are examples of the first aromatic compound (with two (2) functional groups) in FIG. 1A. The process of FIG. 2A then adds 206 third proportion (by mol) of benzene-1,3,5-tricarboxylic acid and also adds 208 a fourth proportion (by mol) of benzene-1,3,5-triol to the reaction vessel. The benzene-1,3,5-tricarboxylic acid and the benzene-1,3,5-triol are examples of the second aromatic compound (with at least three (3) functional groups). A visual depiction of the process of FIG. 2A is shown as the starting materials in FIG. 6A. Specifically, 4-hydroxybenzoic acid and the 6-hydroxy-2-naphthoic acid are shown as the aromatic compounds 620 with two (2) functional groups in FIG. 6A, while the benzene-1,3,5-tricarboxylic acid and the benzene-1,3,5-triol are shown as the aromatic compounds 610 with at least three (3) functional groups in FIG. 6A.

The first proportion, the second proportion, the third proportion, and the fourth proportion together constitute the mixture. For preferred embodiments, the first and second proportions together constitute ˜90% to ˜99% of the mixture, while the third and fourth proportions together constitute ˜1% to ˜10% of the mixture.

Continuing, the process of FIG. 2A adds 210 a fifth proportion (by mol) of acetic anhydride (as a reactant) and, further, adds 212 a sixth proportion (by mol) of dibutyltin oxide (as a catalyst) to the reaction vessel. Insofar as details of adding starting materials are provided above with reference to FIG. 1, further discussion of adding starting materials is omitted herein with reference to FIG. 2A.

FIGS. 2B, 2C, and 2D are flowcharts showing one embodiment of the first heating step 116, the second heating step 124, and the third heating step 132, respectively, of FIG. 1. As shown in FIG. 2B, the first heating step 116 raises 218 the temperature of the vessel to ˜170° C. while stirring the mixture and reflux condensing in a nitrogen gas environment. The content (or reaction vessel) is monitored 220 for a fixed time (e.g., ˜45 min) or a known threshold condition (e.g., sufficient distillation of acetic acid). The process of FIG. 2B is depicted visually in FIG. 6A as an arrow that progresses from the starting materials 610, 620 to intermediates 630.

In FIG. 2C, the second heating step 124 raises 226 the temperature of the vessel to ˜250° C. while stirring the mixture and reflux condensing in a vacuum environment. The content (or reaction vessel) is monitored 228 for a fixed time (e.g., ˜60 min) or a known threshold condition (e.g., complete or near-complete reaction of the reactants). The process of FIG. 2C is depicted visually in FIG. 6A as an arrow that progresses from the intermediates 630 to the end product 640.

In FIG. 2D, the third heating step 132 raises 234 the temperature of the vessel to ˜320° C. while stirring the mixture and reflux condensing in the vacuum environment. The content (or reaction vessel) is monitored 236 for a fixed time (e.g., ˜60 min) or a known threshold condition (e.g., measurable or significant increase in torque required to maintain constant stirring).

Because details associated with the temperature raising 218, 226, 234, stirring, reflux condensing, and monitoring 220, 228, 236 are discussed with reference to FIG. 1, further discussions of those corresponding process steps in FIGS. 2B, 2C, and 2D are omitted herein.

FIG. 3 is a flowchart showing one embodiment of process steps in which specific amounts of starting materials are shown as part of the manufacturing process of FIG. 2A. To be clear, the process steps of FIG. 3 are identical to the process steps of FIG. 2A with only an additional detail of precise mol amounts for each reactant being provided in FIG. 3. Consequently, FIG. 3 shows the process steps of adding 302 approximately three mols (˜3 mol) 4-hydrobenzoic acid, adding 304 ˜3 mol of 6-hydroxy-2-naphthoic acid, adding 306 ˜0.03 mol of benzene-1,3,5-tricarboxylic acid, adding 308 ˜0.03 mol of benzene-1,3,5-triol, adding ˜7.2 mol of acetic anhydride, and adding 312 less than ˜0.01 mol (or, more specifically, ˜0.001205 mol) of dibutyltin oxide to the reaction vessel. Again, insofar as details of adding starting materials are provided above with reference to FIGS. 1A and 2A, further discussion of adding starting materials is omitted herein with reference to FIG. 3.

FIG. 4 is a flowchart showing another embodiment of process steps in which different starting materials are added as part of the manufacturing process, with FIG. 5 showing specific amounts for each component in FIG. 4. For simplicity and convenience, FIGS. 4 and 5 are described together. As shown in FIGS. 4 and 5, the process adds 402, 502 a first proportion (by mol, namely ˜2 mol) of 4-hydrobenzoic acid, adds 404, 504 a second proportion (˜2 mol) of 6-hydroxy-2-naphthoic acid, adds 406, 506 a third proportion (˜0.5 mol) of benzene-1,3,-dicarboxylic acid, adds 408, 508 a fourth proportion (˜0.53 mol) of 4,4′-dyhydroxydiphenyl ether, adds 410, 510 a fifth proportion (˜0.05 mol) of benzene-1,3,5-tricaboxylic acid, and 412, 512 a sixth proportion (namely, a sufficient amount to react with the aforementioned aromatic compounds) of acetic anhydride to the reaction vessel. A smaller seventh proportion (˜0.001205 mol) of dibutyltin oxide is also added 414, 514 as a catalyst to the reaction vessel. Insofar as details of adding starting materials are provided above with reference to FIGS. 1A, 2A, and 3 above, further discussion of adding starting materials is omitted herein with reference to FIGS. 4 and 5.

The embodiments of FIGS. 1 through 11 teach and demonstrate both a powder and a process of manufacturing bPs that have trifunctional moieties 650 (such as those shown in FIG. 6B), bPs having tetrafunctional moieties 660 (such as those shown in FIG. 6C), or a combination of both trifunctional 650 and tetrafunctional 660 moieties. In other words, the disclosed product 640 (FIG. 6A) is a bP that exhibits low dk, low df, low moisture absorbability, and generally isotropic (or uniform) behavior in all directions (including both MD and TD). Consequently, the disclosed bPs can be used in manufacturing flexible printed circuit boards (FPCBs) that are suitable for 5G applications (or other high-frequency applications).

Any process descriptions or blocks in flow charts should be understood as representing steps in a process, in which alternative implementations are included within the scope of the preferred embodiment of the present disclosure, with steps that may be performed out of order from that shown or discussed, including substantially concurrently or in reverse order, depending on the functionality involved, as would be understood by those reasonably skilled in the art of the present disclosure.

Although proper chemical names are provided within this disclosure, it should be understood by those having skill in the art that the same chemical compound may be referenced by different names. For example, benzene-1,3-dicarboxylic acid is also commonly referenced as isophthalic acid, phthalic acid as 1,2-benzenedicarboxylic acid, 4,4′-oxydiphenol as 4,4′-dihydroxydiphenyl ether, and so on.

Although exemplary embodiments have been shown and described, it will be clear to those of ordinary skill in the art that a number of changes, modifications, or alterations to the disclosure as described may be made. All such changes, modifications, and alterations should therefore be seen as within the scope of the disclosure.

What is claimed is:

1. A branched wholly aromatic polyesters (bP), comprising:
a first amount of one or more first aromatic compounds, wherein each of the one or more first aromatic compounds consists of two functional groups, wherein the one or more first aromatic compounds forms one or more repeating units, wherein each of the one or more repeating units is formed at each of the two functional groups, wherein the one or more first aromatic compounds is a product of a reaction between acetic anhydride and one or more first starting aromatic compounds, wherein the one or more first starting aromatic compounds is selected from the group consisting of:
3-hydrobenzoic acid;
4-hydrobenzoic acid;
6-hydroxy-2-naphthoic acid;
phthalic acid;
benzene-1,3-dicarboxylic acid;
terephthalic acid;
4,4′-oxydibenzoic acid;
pyrocatechol;
resorcinol;
4,4′-dihydroxydiphenyl ether;
4,4′-(propane-2,2-diyl)diphenol; and
a combination of 3-hydrobenzoic acid, 4-hydrobenzoic acid, 6-hydroxy-2-naphthoic acid, phthalic acid, benzene-1,3-dicarboxylic acid, terephthalic acid, 4,4′-oxydibenzoic acid, pyrocatechol, resorcinol, 4,4′-dihydroxydiphenyl ether, 4,4′-(propane-2,2-diyl)diphenol; and
a second amount of one or more second aromatic compounds, wherein the second amount is less than the first amount, wherein each of the one or more second aromatic compounds comprises at least three functional groups, wherein the one or more second aromatic compounds is chemically coupled to the one or more repeating units at each of the three functional groups, wherein the chemical coupling produces branching locations in the bP, wherein the one or more second aromatic compounds is a product of a reaction between acetic anhydride and one or more second starting aromatic compounds, wherein the one or more second starting aromatic compounds is selected from the group consisting of:
benzene-1,3,5-triol;
benzene-1,2,4-triol;
benzene-1,2,3-triol;
benzene-1,2,4,5-tetrol;
benzene-1,3,5-tricarboxylic acid;
benzene-1,2,4-tricarboxylic acid;
benzene-1,2,3-tricarboxylic acid;
benzene-1,3,4,5-tetracaboxylic acid;
4,4′-oxydiphthalic acid;
4,4′-oxybis(benzene-1,2-diol); and
a combination of benzene-1,3,5-triol, benzene-1,2,4-triol, benzene-1,2,3-triol, benzene-1,2,4,5-tetrol, benzene-1,3,5-tricarboxylic acid, benzene-1,2,4-tricarboxylic acid, benzene-1,2,3-tricarboxylic acid, benzene-1,3,4,5-tetracaboxylic acid, 4,4′-oxydiphthalic acid, and 4,4′-oxybis(benzene-1,2-diol).

2. The bP of claim 1, wherein:
the one or more first starting aromatic compounds is a combination of:
4-hydrobenzoic acid; and
6-hydroxy-2-naphthoic acid; and
the one or more second starting aromatic compounds is a combination of:
benzene-1,3,5-triol; and
benzene-1,3,5-tricarboxylic acid.

3. The bP of claim 1, wherein:
the one or more first starting aromatic compounds is a combination of:
4-hydrobenzoic acid;
6-hydroxy-2-naphthoic acid;
benzene-1,3-dicarboxylic acid; and
4,4′-dihydroxydiphenyl ether; and
the one or more second starting aromatic compounds is benzene-1,3,5-tricarboxylic acid.

4. A process comprising:
preparing a reaction vessel, wherein the reaction vessel comprises:
a mechanical stirring apparatus;
a torque sensor;
a nitrogen inlet;
a nitrogen gas sensor;
a temperature sensor;
a vacuum coupler; and
a reflux condenser;
adding a first amount of one or more first aromatic compounds to the reaction vessel, wherein each of the one or more first aromatic compounds consists of two functional groups, wherein the one or more first aromatic compounds is selected from the group consisting of:
3-hydrobenzoic acid;
4-hydrobenzoic acid;
6-hydroxy-2-naphthoic acid;
phthalic acid;
benzene-1,3-dicarboxylic acid;
terephthalic acid;
4,4′-oxydibenzoic acid;
pyrocatechol;
resorcinol;
4,4′-dihydroxydiphenyl ether;
4,4′-(propane-2,2-diyl)diphenol; and
a combination of 3-hydrobenzoic acid, 4-hydrobenzoic acid, 6-hydroxy-2-naphthoic acid, phthalic acid, benzene-1,3-dicarboxylic acid, terephthalic acid, 4,4′-oxydibenzoic acid, pyrocatechol, resorcinol, 4,4′-dihydroxydiphenyl ether, 4,4′-(propane-2,2-diyl)diphenol;
adding a second amount of one or more second aromatic compounds to the reaction vessel, wherein the first amount of the one or more first aromatic compounds and the second amount of the one or more second aromatic compounds forms a mixture, wherein the second amount is less than the first amount, wherein each of the one or more second aromatic compounds comprises at least three functional groups, wherein the one or more second starting aromatic compounds is selected from the group consisting of:
benzene-1,3,5-triol;
benzene-1,2,4-triol;
benzene-1,2,3-triol;
benzene-1,2,4,5-tetrol;
benzene-1,3,5-tricarboxylic acid;
benzene-1,2,4-tricarboxylic acid;
benzene-1,2,3-tricarboxylic acid;
benzene-1,3,4,5-tetracaboxylic acid;
4,4′-oxydiphthalic acid;
4,4′-oxybis(benzene-1,2-diol); and
a combination of benzene-1,3,5-triol, benzene-1,2,4-triol, benzene-1,2,3-triol, benzene-1,2,4,5-tetrol, benzene-1,3,5-tricarboxylic acid, benzene-1,2,4-tricarboxylic acid, benzene-1,2,3-tricarboxylic acid, benzene-1,3,4,5-tetracaboxylic acid, 4,4′-oxydiphthalic acid, and 4,4′-oxybis(benzene-1,2-diol);
adding a third amount of a reactant to the reaction vessel, wherein the reactant is acetic anhydride, wherein the third amount of the acetic anhydride is sufficient to react with the mixture;
adding a fourth amount of a catalyst to the reaction vessel, wherein the catalyst is dibutyltin oxide, wherein the fourth amount is less than the third amount, wherein the mixture, the reactant, and the catalyst form a content for the chemical process;
creating a nitrogen environment within the reaction vessel;
raising an inside temperature of the reaction vessel to a first reaction temperature while stirring the content, wherein the first reaction temperature is approximately 170° C., wherein the inside temperature is raised to the first reaction temperature while reflux condensing in the nitrogen environment;
monitoring the content at the first reaction temperature;
determining whether a first reaction at the first reaction temperature is sufficiently complete;
raising, in response to determining that the first reaction is sufficiently complete, the inside temperature of the reaction vessel to a second reaction temperature while drawing a vacuum inside the reaction vessel, wherein the second reaction temperature is approximately 250° C., wherein the inside temperature is raised to the second reaction temperature while stirring the content and reflux condensing;
monitoring the content at the second reaction temperature;
determining whether a second reaction at the second reaction temperature is sufficiently complete;
raising, in response to determining that the second reaction is sufficiently complete, the inside temperature of the reaction vessel to a third reaction temperature while maintaining the vacuum inside the reaction vessel, wherein the third reaction temperature is approximately 320° C., wherein the inside temperature is raised to the third reaction temperature while stirring the content and reflux condensing;
monitoring the content at the third reaction temperature;
determining whether a third reaction at the third reaction temperature is sufficiently complete; and
stopping, in response to determining that the third reaction is sufficiently complete, the process.

5. The process of claim 4, further comprising:
removing a resulting branched wholly aromatic polyester (bP) from the reaction vessel;
pulverizing the bP until finely ground into bP powder;
washing the bP powder with distilled water; and
drying the washed bP powder at approximately 150° C. for approximately one hour (˜1 hr).

6. The process of claim 4, wherein
the first amount of the one or more first aromatic compounds is a combination of:
approximately three mols (˜3 mol) of 4-hydrobenzoic acid; and
˜3 mol of 6-hydroxy-2-naphthoic acid;
the second amount of the one or more second aromatic compounds is a combination of:
˜0.03 mol of benzene-1,3,5-triol; and
˜0.03 mol of benzene-1,3,5-tricarboxylic acid;
the third amount of the reactant is ˜7.2 mol of acetic anhydride; and
the fourth amount of the catalyst is less than ˜0.01 mol of dibutyltin oxide.

7. The process of claim 4, wherein
the first amount of the one or more first aromatic compounds is a combination of:
approximately two mols (˜2 mol) of 4-hydrobenzoic acid;
˜2 mol of 6-hydroxy-2-naphthoic acid;
˜0.5 mol of benzene-1,3-dicarboxylic acid; and
˜0.5 mol of 4,4′-dihydroxydiphenyl ether;
the second amount of the one or more second aromatic compounds is ˜0.05 mol of benzene-1,3,5-tricarboxylic acid;
the third amount of the reactant is ˜7.2 mol acetic anhydride; and
the fourth amount of the catalyst is less than ˜0.01 mol dibutyltin oxide.

8. A process comprising:
preparing a reaction vessel;
adding a first amount of one or more first aromatic compounds to the reaction vessel, wherein each of the one or more first aromatic compounds consists of two functional groups;
adding a second amount of one or more second aromatic compounds to the reaction vessel, wherein the first amount of the one or more first aromatic compounds and the second amount of the one or more second aromatic compounds forms a mixture, wherein the second amount is less than the first amount, wherein each of the one or more second aromatic compounds comprises at least three functional groups;
adding a third amount of a reactant to the reaction vessel, wherein the third amount of reactant is sufficient to react with the mixture;
adding a fourth amount of a catalyst to the reaction vessel, wherein the fourth amount is less than the third amount, wherein the mixture, the reactant, and the catalyst form a content for the chemical process;
creating a nitrogen environment within the reaction vessel;
raising an inside temperature of the reaction vessel to a first reaction temperature while stirring the content and reflux condensing in the nitrogen environment;
monitoring the content at the first reaction temperature;
determining whether a first reaction at the first reaction temperature is sufficiently complete;
raising, in response to determining that the first reaction is sufficiently complete, the inside temperature of the reaction vessel to a second reaction temperature while drawing a vacuum inside the reaction vessel, wherein the inside temperature is raised to the second reaction temperature while stirring the content and reflux condensing;
monitoring the content at the second reaction temperature;
determining whether a second reaction at the second reaction temperature is sufficiently complete;
raising, in response to determining that the second reaction is sufficiently complete, the inside temperature of the reaction vessel to a third reaction temperature while maintaining the vacuum inside the reaction vessel, wherein the inside temperature is raised to the third reaction temperature while stirring the content and reflux condensing;
monitoring the content at the third reaction temperature;
determining whether a third reaction at the third reaction temperature is sufficiently complete; and
stopping, in response to determining that the third reaction is sufficiently complete, the process.

9. The process of claim 8, wherein:
the one or more first aromatic compounds is selected from the group consisting of:
3-hydrobenzoic acid;
4-hydrobenzoic acid;
6-hydroxy-2-naphthoic acid;
phthalic acid;
benzene-1,3-dicarboxylic acid;
terephthalic acid;
4,4′-oxydibenzoic acid;
pyrocatechol;
resorcinol;
4,4′-dihydroxydiphenyl ether;
4,4′-(propane-2,2-diyl)diphenol; and
a combination of 3-hydrobenzoic acid, 4-hydrobenzoic acid, 6-hydroxy-2-naphthoic acid, phthalic acid, benzene-1,3-dicarboxylic acid, terephthalic acid, 4,4′-oxydibenzoic acid, pyrocatechol, resorcinol, 4,4′-dihydroxydiphenyl ether, 4,4′-(propane-2,2-diyl)diphenol; and
the one or more second starting aromatic compounds is selected from the group consisting of:
benzene-1,3,5-triol;
benzene-1,2,4-triol;
benzene-1,2,3-triol;
benzene-1,2,4,5-tetrol;
benzene-1,3,5-tricarboxylic acid;
benzene-1,2,4-tricarboxylic acid;
benzene-1,2,3-tricarboxylic acid;
benzene-1,3,4,5-tetracaboxylic acid;
4,4′-oxydiphthalic acid;
4,4′-oxybis(benzene-1,2-diol); and
a combination of benzene-1,3,5-triol, benzene-1,2,4-triol, benzene-1,2,3-triol, benzene-1,2,4,5-tetrol, benzene-1,3,5-tricarboxylic acid, benzene-1,2,4-tricarboxylic acid, benzene-1,2,3-tricarboxylic acid, benzene-1,3,4,5-tetracaboxylic acid, 4,4′-oxydiphthalic acid, and 4,4′-oxybis(benzene-1,2-diol).

10. The process of claim 9, wherein:
the first amount of the one or more first aromatic compounds is a combination of:
approximately three mols (˜3 mol) of 4-hydrobenzoic acid; and
˜3 mol of 6-hydroxy-2-naphthoic acid;
the second amount of the one or more second aromatic compounds is a combination of:
˜0.03 mol of benzene-1,3,5-triol; and
˜0.03 mol of benzene-1,3,5-tricarboxylic acid;
the third amount of the reactant is ˜7.2 mol of acetic anhydride; and
the fourth amount of the catalyst is less than ˜0.01 mol of dibutyltin oxide.

11. The process of claim 9, wherein:
the first amount of the one or more first aromatic compounds is a combination of:
approximately two mols (˜2 mol) of 4-hydrobenzoic acid;
˜2 mol of 6-hydroxy-2-naphthoic acid;
˜0.5 mol of benzene-1,3-dicarboxylic acid; and
˜0.5 mol of 4,4′-dihydroxydiphenyl ether;
the second amount of the one or more second aromatic compounds is ˜0.05 mol of benzene-1,3,5-tricarboxylic acid;
the third amount of the reactant is ˜7.2 mol acetic anhydride; and
the fourth amount of the catalyst is less than ˜0.01 mol dibutyltin oxide.

12. The process of claim 8, wherein:
the first reaction temperature is approximately 170° C.;
wherein the second reaction temperature is approximately 250° C.; and
the third reaction temperature is approximately 320° C.

13. The process of claim 8, wherein:
the first reaction is sufficiently complete when there has been a threshold amount of acetic acid that has been distilled as a result of the stirring at the first reaction temperature.

14. The process of claim 8, wherein:
the first reaction is sufficiently complete when the content has been stirred for approximately forty-five minutes (˜45 min) in the nitrogen environment at the first reaction temperature.

15. The process of claim 8, wherein:
the second reaction is sufficiently complete when substantially all of the mixture has reacted with the acetic anhydride as a result of stirring at the second reaction temperature.

16. The process of claim 8, wherein:
the second reaction is sufficiently complete when substantially all of the acetic anhydride has reacted with the mixture as a result of stirring at the second reaction temperature.

17. The process of claim 8, wherein
the second reaction is sufficiently complete when the content has been stirred for approximately sixty minutes (˜60 min) in the vacuum environment at the second reaction temperature.

18. The process of claim 8, wherein
the third reaction is sufficiently complete when a measured torque for stirring at the third reaction temperature increases measurably.

19. The process of claim 8, wherein
the third reaction is sufficiently complete when the content has been stirred for approximately sixty minutes (˜60 min) in the vacuum environment at the third reaction temperature.

20. The process of claim 8, further comprising:
removing a resulting branched wholly aromatic polyester (bP) from the reaction vessel;
pulverizing the bP until finely ground into bP powder;
washing the bP powder with distilled water; and
drying the washed bP powder.
